(19) United States
(12) Patent Application Publication
(10) Pub. No.: US 2003/0057622 A1
(43) Pub. Date: Mar. 27, 2003

(54) Slipper bushing

(76) Inventors: Vincent G. Bovio, Ann Arbor, MI (US); Paul D. Cottrell, Ortonville, MI (US)

Correspondence Address: SAND & SEBOLT, 4801 DRESSLER RD., N.W., SUITE 194, CANTON, OH, 44718, US

(21) Appl. No.: 09/967,273

(22) Filed: Sep. 27, 2001

(51) Int. Cl. F16F 1/38

(52) U.S. Cl. 267/281; 267/292

(57) ABSTRACT

A slipper bushing includes a series of coaxially disposed cylindrical components. The slipper bushing has an outer sleeve, a resilient member coaxially disposed within and secured to the outer sleeve, a rigid, self-lubricating bearing coaxially disposed within the resilient member and an inner sleeve coaxially disposed within the bearing.

### BACKGROUND OF THE INVENTION

1. Technical Field

This invention generally relates to bushings, and more particularly to slipper bushings of the type having concentric inner and outer cylindrical sleeves that have a resilient layer disposed between the inner and outer sleeves; wherein the bushings further include a slip surface disposed between concentric layers.

2. Background Information

Slipper bushings are commonly used in automobiles in locations such as the suspension system, where two components need to cooperate with each other, but one component remains stationary and the other component moves. The bushings are used to connect the two components together.

Exemplary slipper bushings and patents are Nicoles (U.S. Pat. No. 6,170,812 B1); Chakko (U.S. Pat. No. 5,139,244) Tanaka et al (U.S. Pat. No. 4,744,677) and Stevenson et al (U.S. Pat. No. 5,820,115). Each of these patents discloses a slipper bushing that has concentric, cylindrical inner and outer sleeves with a resilient layer disposed between them. The resilient layer is secured to one of the inner and outer sleeves and a mechanism is provided to allow the outer sleeve to rotate relative to the inner sleeve. An additional mechanism is provided to prevent the inner and outer sleeves from moving axially relative to each other.

Chakko, (U.S. Pat. No. 5,139,244) utilizes a lubricated inner surface of the outer sleeve to permit rotation of the outer sleeve relative to the inner sleeve. End caps are utilized to prevent the contamination of the lubricated interface. The surface of the resilient member that contacts the outer sleeve is lubricated to allow for rotation of the outer sleeve relative to the inner sleeve/resilient member combination. Tanaka et al (U.S. Pat. No. 4,744,677) discloses a bushing having inner and outer sleeves in a concentric, spaced-apart relationship to each other. A rigid sleeve member is disposed between the inner and outer sleeves, a resilient member is disposed between the outer sleeve and the rigid sleeve member and a cylindrical sliding member is disposed between the rigid sleeve member and the inner member. The cylindrical sliding member includes a pair of bushings made of oil-containing plastic such as polyacetal resin. An annular hollow space 50 is formed by the insertion of the inner sleeve 12 into the bushes 18. The space 50 may be used to hold lubricant that has been smeared on the slidable surface of the bushes 18. The surface of the bushes also include four axial grooves 46 which facilitate the movement of lubricant from the space 50 along the surface of the bushes 18.

Similarly, Nicoles (U.S. Pat. No. 6,170,812 B1) discloses a slipper bearing that has a radial bearing sleeve 24 made from nylon and that includes grease grooves 34 for holding lubricant to reduce the break away torque of the bearing sleeve 24.

The bushings of the prior art have functioned fairly well, but some of them have been unnecessarily complex and because they have used lubrication to reduce the friction between components, they have been subject to possible contamination of the lubricated surfaces and consequent premature wearing and decay of the components.

### BRIEF SUMMARY OF THE INVENTION

The device of the present invention has inner and outer sleeves concentrically arranged. A resilient member is disposed between the inner and outer sleeves and a self-lubricating slip surface is disposed between the resilient member and one of the inner and outer sleeves.

### BRIEF DESCRIPTION OF THE SEVERAL VIEWS OF THE DRAWINGS

FIG. 1 is a perspective view of a portion of the suspension system of an automobile.

FIG. 2 is a perspective view of the slipper bushing of the present invention.

FIG. 3 is an exploded perspective view of the slipper bushing of FIG. 2.

FIG. 4 is a cross sectional view of the bushing through line 4-4 of FIG. 1.

FIG. 5 is a cross sectional view of the bushing through line 5-5 of FIG. 4.

FIG. 6 is a perspective view of an axle including the slipper bushing of the present invention.

FIG. 7 is a cross sectional view of the bushing showing rotational motion of the outer sleeve relative to the inner sleeve.

### DETAILED DESCRIPTION OF THE INVENTION

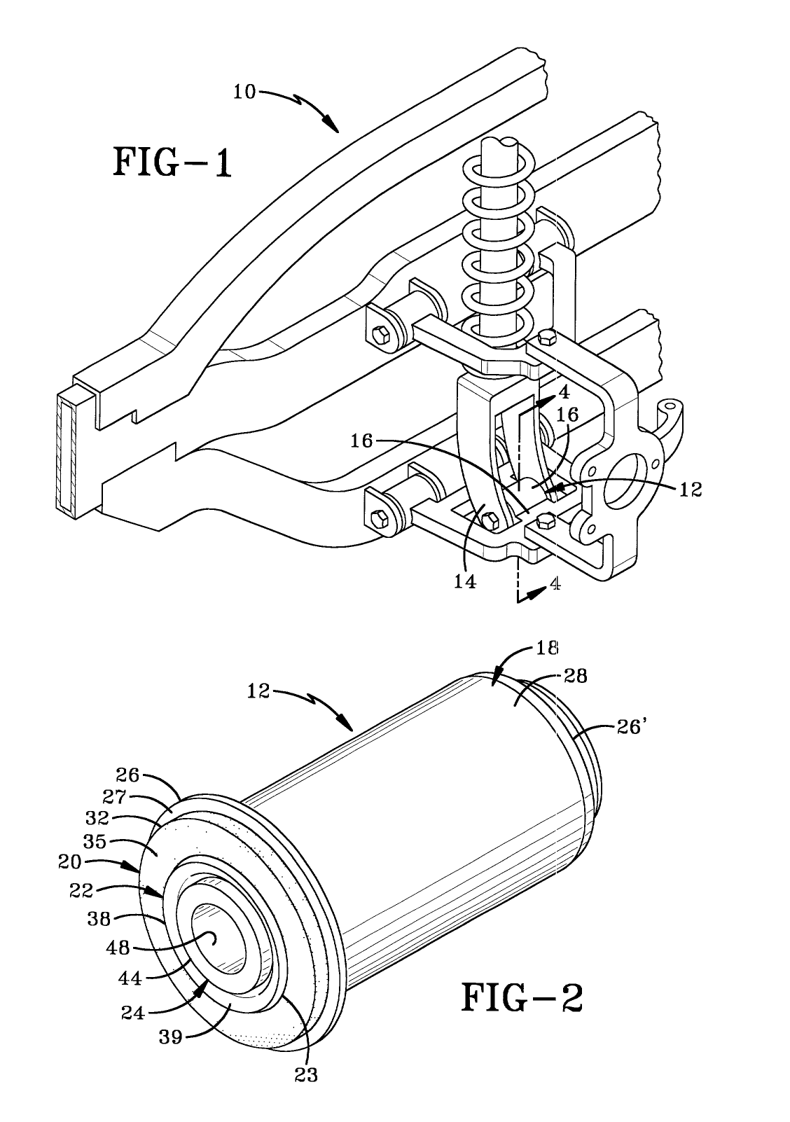

FIG. 1 shows part of an automobile suspension system generally indicated by the numeral 10. A slipper bushing, generally indicated by the numeral 12, connects the non-rotatable shock absorber yoke 14 to a rotatable member or control arm 16. As shown in FIG. 2, slipper bushing 12 includes an outer sleeve 18, a resilient member 20, a bearing 22 and an inner sleeve 24. The components of bushing 12 are concentrically arranged. Although slipper bushing 12 is shown on automobile suspension system 10, it should be noted that the essence of the invention lies within bushing 12 and may be used in a variety of applications including, but not limited to, suspension systems.

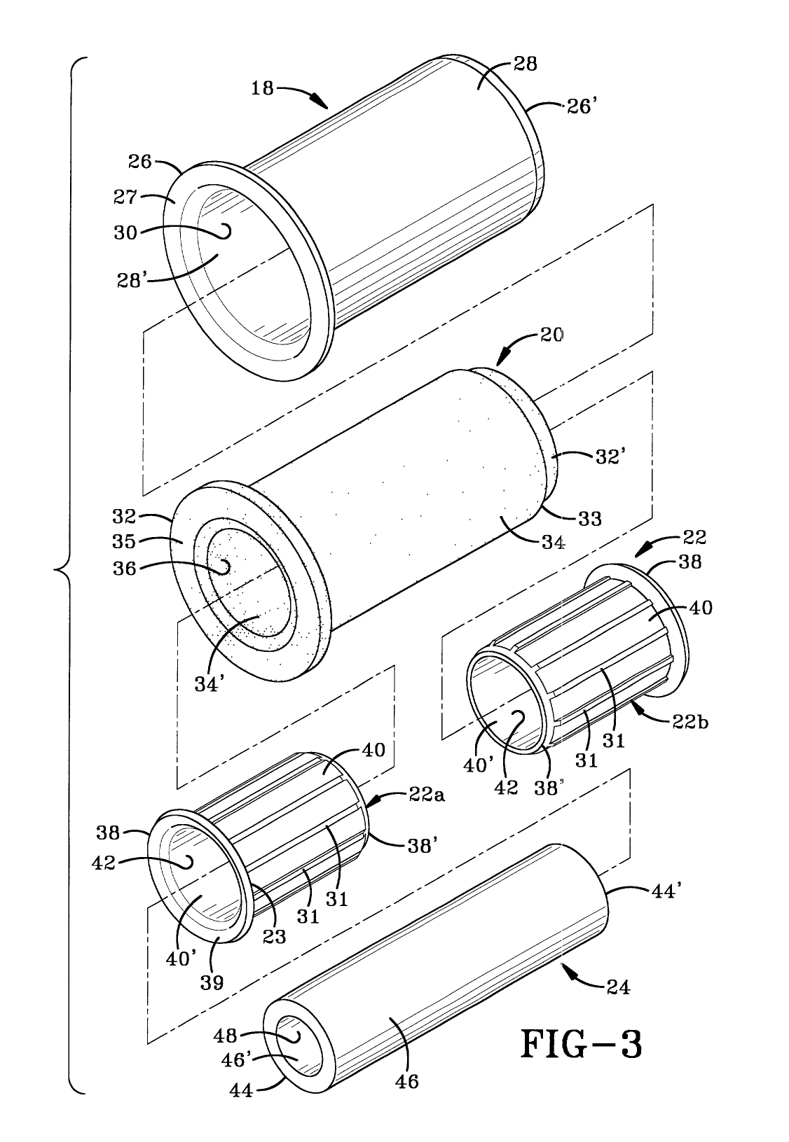

Referring to FIG. 3, outer sleeve 18 is a rigid cylinder manufactured out of a suitable material such as steel, aluminum, ceramic, plastic etc. Outer sleeve 18 has first and second ends 26, 26′, and exterior and interior surfaces 28, 28′. Outer sleeve 18 defines a bore 30 having a longitudinal centerline. First end 26 is formed into a radially outwardly extending flange 27. Exterior surface 28 is smooth and is interferencely fit into control arm 16. However, in the event that slipper bushing 12 is undersized, it may be narrowed or grooved or otherwise provided with a frictional surface in order to provide a more aggressive interconnection with control arm 16.

Resilient member 20 has a generally cylindrical body that defines a bore 36 having a longitudinal centerline. Resilient member 20 has first and second ends 32, 32′ and exterior and interior surfaces 34, 34′. First end 32 is flanged and second end 32′ is stepped down at 33 to have a smaller diameter than the rest of resilient member 20. The stepped down portion of second end 32′ allows resilient member 20 to be more easily inserted into bore 30 of outer sleeve 18. Additionally, the stepped down shape of second end 32′ allows for the easy extraction of resilient member 20 from a mold after curing. Still further, the stepped down portion at 33 allows for a simpler installation to the vehicle component or rotatable member 16. Resilient member 20 may be manufactured from rubber or any other suitable material. In one method of assembly, resilient member 20 is receivable in bore 30 of outer sleeve 18 and exterior surface 34 of resilient member 20 is bonded to interior surface 28′ of outer sleeve 18 using a suitable adhesive. However, in order to more aggressively secure resilient member 20 to interior surface 28′ of outer sleeve 18, the rubber is mold bonded to the outer sleeve. More particularly, outer sleeve 18 is placed within a mold after the interior surface 28′ thereof has been coated with a suitable adhesive. The rubber is then forced into the mold where it is simultaneously cured and bonded by way of the adhesive to outer sleeve 18.

Bearing 22 may be formed from two similarly-shaped rigid cylindrical sections 22a and 22b. While the following describes section 22a, section 22b has similar characteristics. Section 22a has first and second ends 38, 38′, and exterior and interior surfaces 40, 40′. Section 22a also defines a bore 42 having a longitudinal centerline. First end 38 has a radially outwardly extending flange 39. Outwardly extending flange 39 assists in the reaction of axial loading on slipper bushing 12 when acting in a suspension system 10 or similar arrangement. More particularly, when axial force acts upon suspension system 10, it will pass through slipper bushing 12 by way of rotatable member 16. As this axial force is passed into slipper bushing 12, it will react, at least partially, through outwardly extending flange 39. This greatly reduces the stress on the interaction between bearings 22 and resilient member 20. In order to assist in the frictional engagement between bearings 22 and resilient member 20, each bearing is formed with a plurality of longitudinal ribs 31 extending axially along the length of exterior surface 40. In this manner, ribs 31 will provide mechanical engagement with resilient member 20 in order to assure that rotational movement is taken up within the appropriate portions of slipper bushing 12.

Additionally, a first end 38 of each of bearings 22a and 22b provides a sealing function as will be described in more detail below. Bearing sections 22a, 22b are adapted to be received within bore 36 of resilient member 20. Second ends 38′ may be formed with a chamfer 33 to aid in the insertion of sections 22a, 22b into bore 36. Bearing sections 22a, 22b are press fit into bore 36 during assembly of slipper bushing 12. As set forth above, exterior surface 40 of bearings 22a and 22b include ribs or splines 31 to create a mechanical engagement with interior surface 34′ of resilient member 20. When sections 22a, 22b are inserted into bore 36, a small gap 57 exists between second ends 38′, 38′. This ensures that there is a close fit between flanged first end 38 and first or second end 32, 32′ of resilient member 20. Bearing 22 is manufactured from a self-lubricating material. Suitable materials include PV80 and PV102 made by Railko Limited of England. To form these two plastics, Railko Limited modifies acetal copolymer and high density polyethylene by introducing mineral oil into them. The oil is evenly distributed throughout the component in numerous non-connecting micro pockets. This gives lubrication to the component throughout 0its life. Bearing 22 has low friction, generally below 0.1 μ, zero stick-slip, reduced or zero lubrication and an improved wear life because of the use of self-lubricating material. Bearing 22 may be manufactured from any other material having similar properties.

Inner sleeve 24 is a rigid cylinder manufactured out of a suitable material such as steel, aluminum, ceramic or other rigid materials known in the art. Inner sleeve 24 has first and second ends 44, 44′ and exterior and interior surfaces 46,46′. Sleeve 24 defines a bore 48 having a longitudinal centerline. Inner sleeve 24 is adapted to be received within bore 42 of bearing 22. Exterior surface 46 of inner sleeve 24 is adapted to slidingly engage interior surface 40′ of bearing sections 22a, 22b. Further, inner sleeve 24 may be provided with a corrosion protective coating in order to prevent undue corrosion during use.

During the assembly of slipper bushing 12, interior surface 28′ of outer sleeve 18 is coated with an adhesive before it is placed into the mold. Once the outer sleeve 18 is placed in the mold, rubber is injected into the mold where it is simultaneously cured and bonded by way of the adhesive layer to inner surface 28′ of outer sleeve 18. As such, there is a mechanical connection given that resilient member 20 is cured within outer sleeve 18, as well as an adhesive innerconnection between these members. The diameter of flanged end 32 of resilient member 20 is slightly smaller than the diameter of flanged end 26 of outer sleeve 18. During curing, the flow of rubber is shut off so that no material gets on the outer surface of outer sleeve 18 to assure a strong mechanical inner connection between the outer surface 28 of outer sleeve 18 and rotatable member 16.

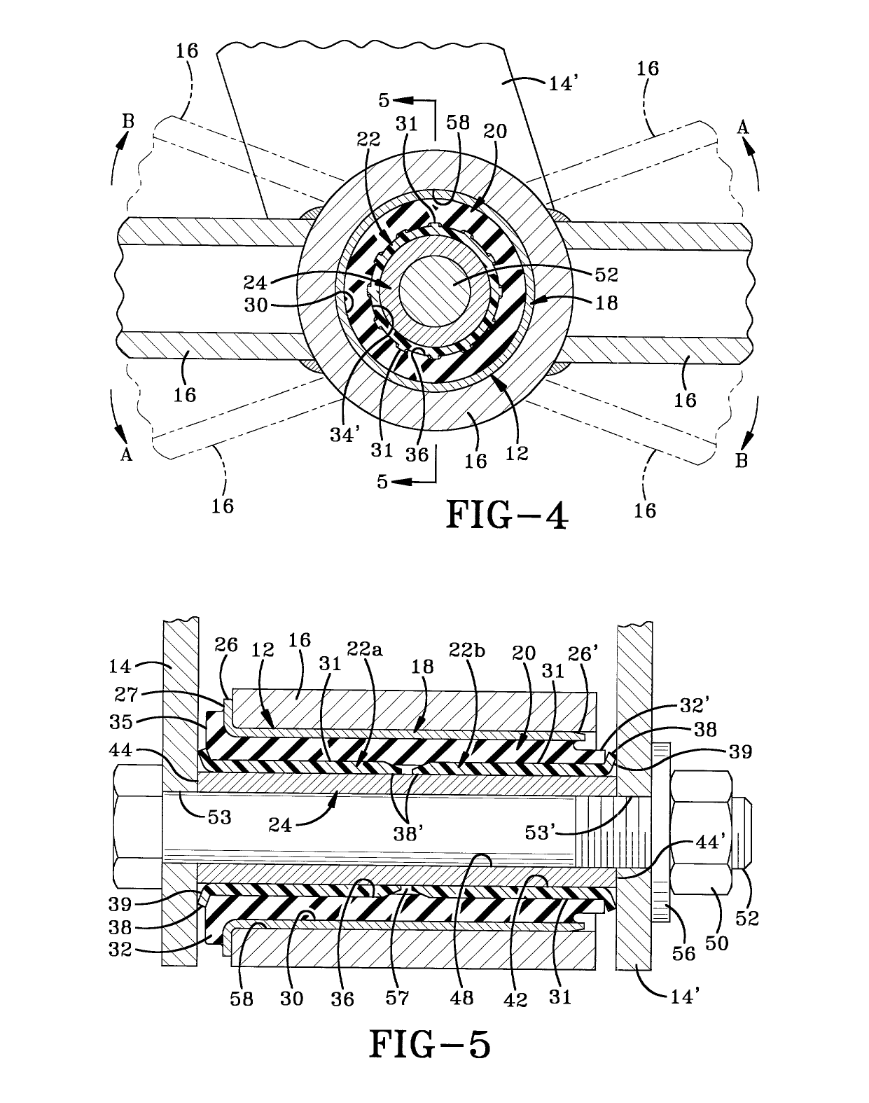

Second end 38′ of bearing section 22a is then inserted into bore 36 of resilient member 20. Bearing section 22a is press fit into bore 36 so that flanged first end 38 of bearing section 22a abuts flanged first end 32 of resilient member 20. Inner surface 23 of flanged first end 38 of bearing section 22a abuts outer surface 35 of flanged first end 32 of resilient member 20. The diameter of flanged first end 38 of bearing section 22a is similar to the diameter of flanged first end 38 of bearing section 22b. Second end 38′ of bearing section 22b is inserted and press fit into the opposite end of bore 36 so that flanged first end 38 of bearing section 22b abuts second end 32′ of resilient member 20. A small gap 57 remains between second ends 38, 38′ of bearing sections 22a, 22b (FIG. 5). Ribs 31 extending along the exterior surface 40 of bearing sections 22a and 22b extend outwardly to push into resilient member 20. Inner sleeve 24 is then inserted and press fit into bore 42 of bearing 22.

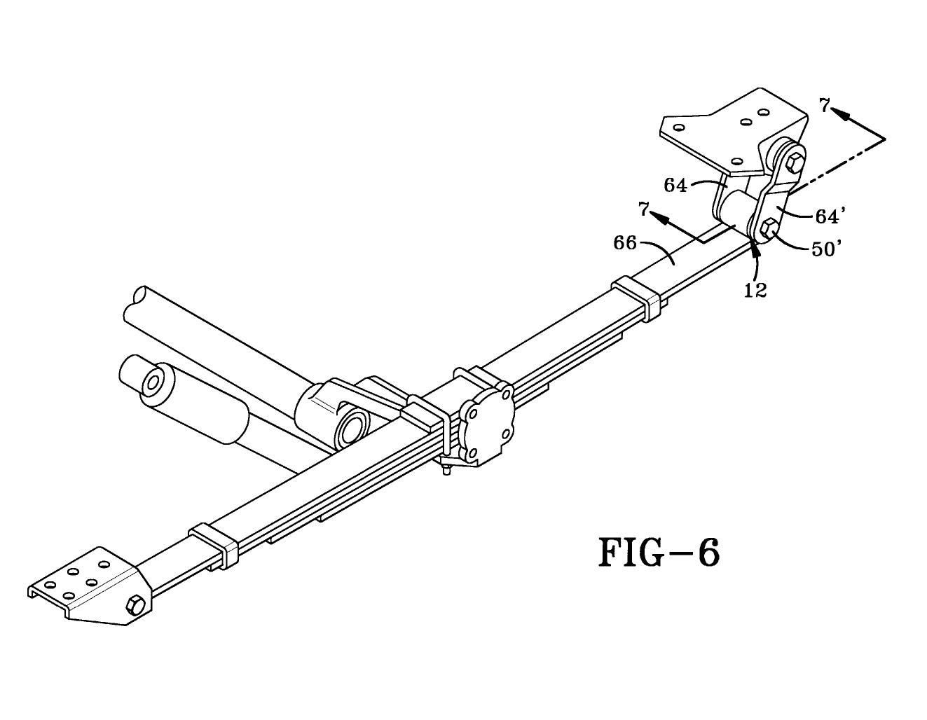

Slipper bushing 12 is connected to the relevant component in which it is to function, for example a spring/shock absorber yoke (FIG. 1) or a leaf spring eye (FIG. 6). Although the use of slipper bushing 12 in these environments is provided by way of example, slipper bushing 12 may be used in a variety of environments without departing from the spirit of the present invention. Slipper bushing 12 may be connected to the component by any suitable mechanism including a nut 50 and bolt 52 (FIG. 5). Referring to FIG. 1, yoke arms 14, 14′ each define an aperture 53, 53′. Bolt 52 is inserted through first aperture 53 of yoke arm 14, into bore 48 of inner sleeve 24 and through second aperture 53′ of yoke arm 14′. A washer 56 is slipped onto bolt 52 so that it abuts yoke arm 14′ and nut 50 is threaded onto bolt 52 and is tightened securely. This effectively connects inner sleeve 24 to a non-rotating component of the suspension system.

Bushing 12 is press fit into a rotatable member such as rotatable member 16 (FIG. 1) such that exterior surface 28 frictionally engages the interior surface 58 of rotatable member 16 (FIGS. 4 & 5). This engagement causes outer sleeve 18 to move with control arm 16. Control arm 16 may be rotated between at least a first position A and a second position B. When this rotation occurs, outer sleeve 18 rotates with rotatable member 16. Resilient member 20 rotates with outer sleeve 18 because member 20 is bonded to outer sleeve 18. Similarly, bearings 22a and 22b rotate with the rotation of resilient member 20 as a result of the interaction between the inner surface of resilient member 20 and ribs 31 of bearings 22a and 22b. Inasmuch as bearings 22a and 22b move with resilient member 20, no slippage occurs therebetween. Inner sleeve 24 is then placed within bearings 22a and 22b adjacent interior surface 40′ of bearings 22a and 22b. Interior surfaces 40′ of bearings 22 and exterior surface 46 of inner sleeve 24 thus are movable with respect to each other. More particularly, the interaction of these surfaces provides for slippage given the relatively low friction of the material out of which bearings 22 are manufactured. This also assures that bearing 22 does not require any additional lubrication, substantially reducing the cost of the manufacture of the bearing as well as the cost of the installation thereof.

During assembly, flange 39 of end 38 of bearings 22 is abutted against the end of exterior surface of resilient member 20, as shown more particularly in FIG. 5. In this manner, the flange of the bearing seals the area between resilient member 20 and bearing 22 as well as between suspension system 10 and the inner sleeve to minimize contamination of the slipping surfaces 40′ and 46 by dust and other foreign particles. Although lubrication is not necessary intermediate slipping surfaces 40′ and 46, contaminants will prematurely wear bearings 22 as well as inner sleeve 24 causing premature joint failure. Although the joint may never wear entirely through, it will substantially loosen the joint by reducing the thickness of bearings 22 and inner sleeve 24 resulting in less than satisfactory performance.

In summary, slipper bushing 12 provides for a reaction to axial, radial, vertical, and horizontal forces. Resilient member 20 provides reaction and cushioning to vertical and horizontal forces applied to the bushing. Inasmuch as rotational movement of this bushing is provided only by the relative rotational movement of inner sleeve 24 and bearings 22, all other forces may be reacted in the intended manner without degradation or loss of function as a result of rotational forces.

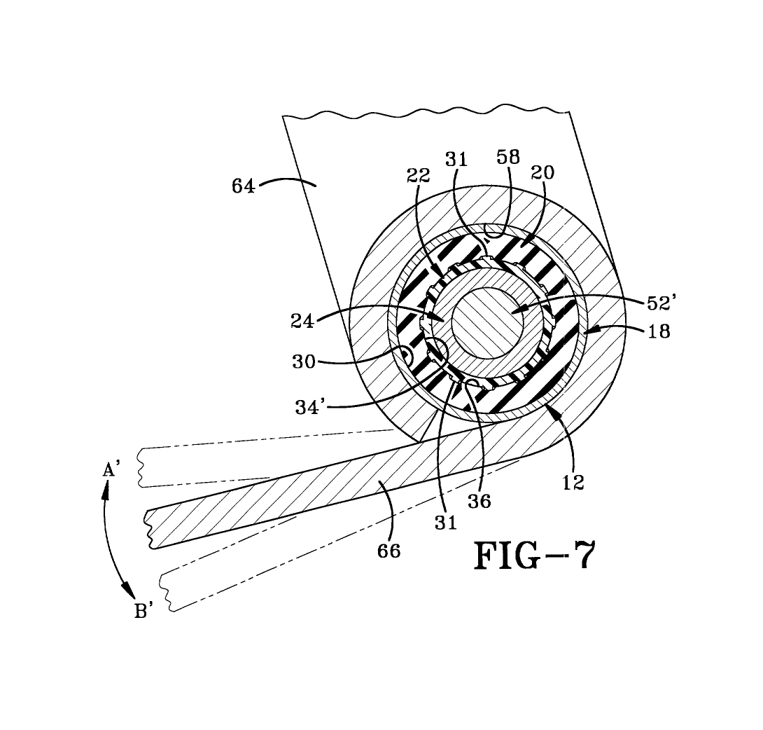

Referring to FIGS. 6 and 7, a slipper bushing 12 may also be adapted to connect shackle arms 64, 64′ to a leaf spring 66. Inner sleeve 24 is connected to shackle arms 64, 64′ by way of a nut 50′ and bolt 52′. Outer sleeve 18 has interference, non-slip fit with the interior surface 58 of leaf spring 66. Leaf spring 66 rotates between at least a first position A′ and a second position B′. When this rotation occurs, outer sleeve 18 rotates with leaf spring 66. As previously described, resilient member 20 rotates with outer sleeve 18 because they are bonded together. Bearings 22a and 22b will rotate with resilient member 20 as a result of the action between the inner surface of the resilient member 20 and ribs 31 of bearings 22a and 22b and slippage (movement) will occur between slipping surfaces 40′ and 46 without the need for additional lubrication.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A slipper bushing for connecting a rotatable component and a non-rotatable component, the slipper bushing comprising:
an outer sleeve adapted to be connected to the rotatable component, the outer sleeve having first and second ends and defining a first longitudinal bore;
a resilient member disposed within the first bore, the resilient member having first and second ends and defining a second longitudinal bore;
a self-lubricating bearing disposed within the second bore, the bearing having first and second ends and defining a third bore; and
an inner sleeve disposed within the third bore, the inner sleeve having first and second ends and defining a fourth bore, the inner sleeve adapted to be connected to the non-rotatable component.

2. The slipper bushing of claim 1 wherein the bearing is made from acetal copolymer.

3. The slipper bushing of claim 2, wherein the bearing has oil encapsulated within the acetal copolymer.

4. The slipper bushing of claim 3, wherein the oil is mineral oil.

5. The slipper bushing of claim 1 wherein the bearing is made from high density polyethylene.

6. The slipper bushing of claim 5, wherein the bearing has oil encapsulated within the polyethylene.

7. The slipper bushing of claim 6, wherein the oil is mineral oil.

8. The slipper bushing of claim 1, wherein the outer sleeve has an exterior surface adapted for frictional engagement with the rotatable component.

9. The slipper bushing of claim 8 wherein the outer sleeve is abutted to be interferencely fit within the rotatable component.

10. The slipper bushing of claim 1 wherein the exterior surface of the outer sleeve is at least partially knurled.

11. The slipper bushing of claim 9, wherein at least one of the first end of the outer sleeve, resilient member, and bearing is flanged.

12. The slipper bushing of claim 1, wherein the bearing includes first and second portions, each of said first and second portions having a first end and a second end.

13. The slipper bushing of claim 12, wherein each of the first ends of the bearings are flanged.

14. The slipper bushing of claim 13, wherein the flanged first ends of the bearings are abutted to at least partially contact the non-rotatable member to prevent debris from entering the area between the non-rotatable component and said bushing.

15. The slipper bushing of claim 1, wherein the slipper bushing is free of end caps.

16. The slipper bushing of claim 1, wherein the resilient member is secured to the outer sleeve with adhesive.

17. The slipper bushing of claim 16, wherein the resilient member is cured inside the outer sleeve during manufacture.

18. The slipper bushing of claim 17, wherein the second end of the resilient member is of reduced diameter.

19. The slipper bushing assembly comprising:
a rotatable member;
a non-rotatable member;
an outer sleeve having a first bore and connected to one of the non-rotatable member and rotatable member;
a resilient member disposed within the first bore and being formed with a second bore;
a self-lubricating bearing disposed within the second bore and being formed with a third bore; and
an inner sleeve connected to one of the non-rotatable member and rotatable member and disposed within the third bore.

20. The slipper bushing of claim 19, wherein the outer sleeve is press fit into the rotatable member.

21. The slipper bushing of claim 20, wherein the resilient member is adhesively attached to the outer sleeve and in which the resilient member is cured inside the outer sleeve.

22. The slipper bushing of claim 21, wherein movement is permitted in which the inner sleeve rotates relative to the bearing.

23. The slipper bushing of claim 22, wherein at least one of the first end of the outer sleeve, resilient member, and bearing is provided with a flange extending outwardly therefrom.

24. The slipper bushing of claim 23, wherein the bearing is flanged on at least one end; and in which said flange partially contacts the non-rotatable member and is adapted to prevent debris from entering the area between the non-rotatable component and said bushing.

25. The slipper bushing of claim 24 wherein the bearing is, made from acetal copolymer.

26. The slipper bushing of claim 25, wherein the bearing has oil encapsulated within the acetal copolymer.

27. The slipper bushing of claim 26, wherein the oil is mineral oil.

28. The slipper bushing of claim 24 wherein the bearing is made from high density polyethylene.

29. The slipper bushing of claim 28, wherein the bearing has oil encapsulated within the polyethylene.

30. A slipper bushing assembly comprising:
a rotational component;
a non-rotational component;
a first reaction member for reacting to rotational forces;
a second reaction member for reacting to axial forces;
a third reaction member for reacting to horizontal and vertical radial forces;

31. The slipper bushing assembly of claim 30, wherein the first reaction member includes a stationary member and a rotating member and in which one of the stationary and rotating member is made of a self-lubricating material.

32. The slipper bushing assembly of claim 31, wherein the rotating member may rotate around the non-rotating member.

33. The slipper bushing assembly of claim 31, wherein this second reaction member includes an annular flange extending between the rotating member and the non-rotating member.

34. The slipper bushing assembly of claim 31, further comprising an outer sleeve; an inner sleeve; and a resilient bushing extending intermediate the outer sleeve and the inner sleeve.

35. The slipper bushing of claim 34 wherein the self-lubricating material is a acetal copolymer.

36. The slipper bushing of claim 35, wherein the self-lubricating material has oil encapsulated within the acetal copolymer.

37. The slipper bushing of claim 36, wherein the oil is mineral oil.

38. The slipper bushing of claim 34 wherein the bearing is made from high density polyethylene.

39. The slipper bushing of claim 38, wherein the bearing has oil encapsulated within the polyethylene.
